(19) United States
(12) Patent Application Publication
(10) Pub. No.: US 2005/0065936 A1
(43) Pub. Date: Mar. 24, 2005

(54) System and method for reusing form elements in a form building application

(76) Inventor: Thomas Goering, Wiesloch (DE)

Correspondence Address: KENYON & KENYON, 1500 K STREET, N.W., SUITE 700, WASHINGTON, DC, 20005, US

(21) Appl. No.: 10/665,305

(22) Filed: Sep. 22, 2003

(51) Int. Cl. G06F 17/00

(52) U.S. Cl. 707/100

(57) ABSTRACT

A method and system for generating output modules in a form-based application runtime environment. According to one embodiment, a form manager receives an indication that a reusable form element has been changed, determines which output modules from a set of output modules are affected by the changed form element, and invalidates the affected output modules, and a runtime manager receives a request for an output module from the set of output modules and regenerates the requested output module if the requested output module has been invalidated.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

Electronic forms serve an integral role in organizing information flow for today's business applications. Such forms are widely used to manage and present business data for such enterprise business applications as Customer Relationship Management (CRM), Sales and Distribution (SD), Financial Accounting (FI) and Human Resources (HR). To reduce the amount of programming skills necessary for creating and maintaining these forms, development tools have been created to enable users to design the look-and-feel of business forms in a graphical environment without coding. One such tool is the Smart Forms Form Builder application provided by SAP AG, Walldorf, Germany.

The graphical user interface (GUI) of the currently available Smart Forms Form Builder tool is depicted in FIG. 1. The GUI comprises three sections: navigation tree 100, maintenance screen 110 and form painter 120. Navigation tree 100 provides a tree structure of nodes that represent the output elements of the form such as pages, windows, graphics, tables, text areas, etc. Based on the selected node, maintenance screen 110 provides the area for inserting texts, establishing paragraph and character formats, setting up different attributes (fonts, borders, shading, etc.), or drawing tables and templates. Form painter 120 enables users to design the layout of the form.

The root nodes in navigation tree 100 are “Global Settings” and “Pages and windows”. “Global Settings” has three directly inferior nodes: “Form attributes”, “Form interface” and “Global definitions”. Upon selection of the “Form attributes” node, maintenance screen 110 enables the user to set attributes for the entire form, such as language attributes for the translation process, page format, style and default output settings. Upon selection of the “Form interface” node, maintenance screen 110 enables the user to define the parameter interface through which the form retrieves relevant application data from an application program. And upon selection of the “Global definitions” node, maintenance screen 110 enables the user to define variables and/or constants for use throughout the form.

“Pages and windows” has two directly inferior page nodes: “FIRST” and “NEXT”. Form painter 120 displays the directly inferior nodes of the “FIRST” page node, which include one graphic node (“MYSAPCOM”) and four window nodes (“MAIN”, “ADDRESS”, “INFO” and “FOOTER”). “MAIN” includes two text nodes (“INTRODUCTION” AND “GREETINGS”) and a table node (“TABLE”).

Once a form is created, it may be activated by clicking activation button 130, upon which the Smart Forms runtime system checks the form and automatically generates an ABAP function module (i.e., form output module) that can subsequently be called by an application program, for example, to create delivery notes in Sales and Distribution. The form output module processes the imported application-specific data and its form description data for presentation via spool (printer), fax, e-mail, web browser, etc. Since retrieval of application-specific data is performed by the application program and then passed to the form output module, a clean separation of the data retrieval processes is established from the form design processes so that only changes to the form layout or form logic are made in the form building application.

Currently, form building applications enable a limited type of reusability that allows a user to reuse simple text fields in forms. For example, suppose a user develops 100 different forms for company use, and each of the forms has an address node that includes a text field for the company's address. If the text field is reusable, then after all 100 forms have been activated, the user can change the company's address once at one location, and the change will automatically be incorporated into all 100 forms. This type of reusability is implemented by allowing text fields to be incorporated by reference into forms in such a way that the corresponding activated forms (i.e., form output modules) need only reference a text element from a central location during runtime.

Current form building applications do not, however, allow users to reuse form elements besides simple text fields. For example, suppose a user develops 100 different forms for company use, and each of the forms has the same subset of window nodes (e.g., nodes which establish a corporate identity). There is currently no way to change that subset of window nodes as a group without changing and reactivating each of the 100 forms. This is due to the fact that higher-level form elements cannot be merely incorporated by reference into form output modules, but rather must be generated into the output module.

Accordingly, there is a need in the art for a system and method for reusing higher-level form elements in a form building application.

### SUMMARY OF THE INVENTION

Embodiments of the present invention provide for generating output modules in a form-based application runtime environment. According to one embodiment, a form manager receives an indication that a reusable form element has been changed, determines which output modules from a set of output modules are affected by the changed form element, and invalidates the affected output modules, and a runtime manager receives a request for an output module from the set of output modules and regenerates the requested output module if the requested output module has been invalidated.

### BRIEF DESCRIPTION OF THE DRAWINGS

FIG. 1 is a screen shot of a form building application as known in the art.

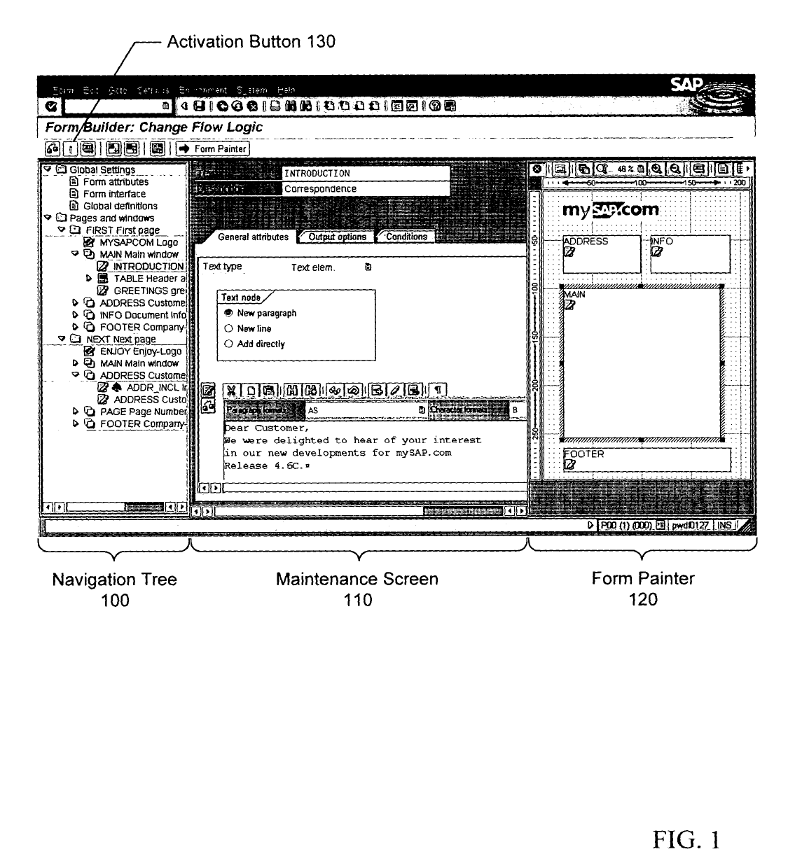

FIG. 2 is a flow chart that depicts a process for reusing form elements in a form-based application runtime environment in accordance with an embodiment of the present invention.

FIG. 3 is a block diagram that depicts a client computing device in accordance with an embodiment of the present invention.

FIG. 4 is a block diagram that depicts a network architecture for a form-based application runtime environment in accordance with an embodiment of the present invention.

FIG. 5 is a block diagram of a form-based application runtime environment in accordance with an embodiment of the present invention.

FIG. 6 is a block diagram of a data structure representing a form record in accordance with an embodiment of the present invention.

FIG. 7 is a block diagram of a data structure representing a form element record in accordance with an embodiment of the present invention.

FIG. 8 is a sequence diagram that depicts the flow of a form-based application runtime environment during incorporation of a reusable form element in a form building application in accordance with an embodiment of the present invention.

FIG. 9 is a sequence diagram that depicts the flow of a form-based application runtime environment during modification of a reusable form element in accordance with an embodiment of the present invention.

FIG. 10 is a sequence diagram that depicts the flow of a form-based application runtime environment during a call to execute an output module in accordance with an embodiment of the present invention.

FIG. 11 is a UML class diagram for reusable form elements in accordance with an embodiment of the present invention.

FIG. 12 is a screen shot of a GUI for building reusable form pages in accordance with an embodiment of the present invention.

FIG. 13 is a screen shot of a GUI for building reusable form logic in accordance with an embodiment of the present invention.

FIG. 14 is a screen shot of a GUI for incorporating reusable form logic into a form building application in accordance with an embodiment of the present invention.

FIG. 15 is a screen shot of a GUI for building reusable form interfaces in accordance with an embodiment of the present invention.

FIG. 16 is a screen shot of a form building application incorporating reusable form interfaces in accordance with an embodiment of the present invention.

FIG. 17 is a screen shot of a form building application incorporating reusable form interfaces in accordance with an embodiment of the present invention.

FIG. 18 is a screen shot of a form building application incorporating reusable form interfaces in accordance with an embodiment of the present invention.

### DETAILED DESCRIPTION

### OVERVIEW

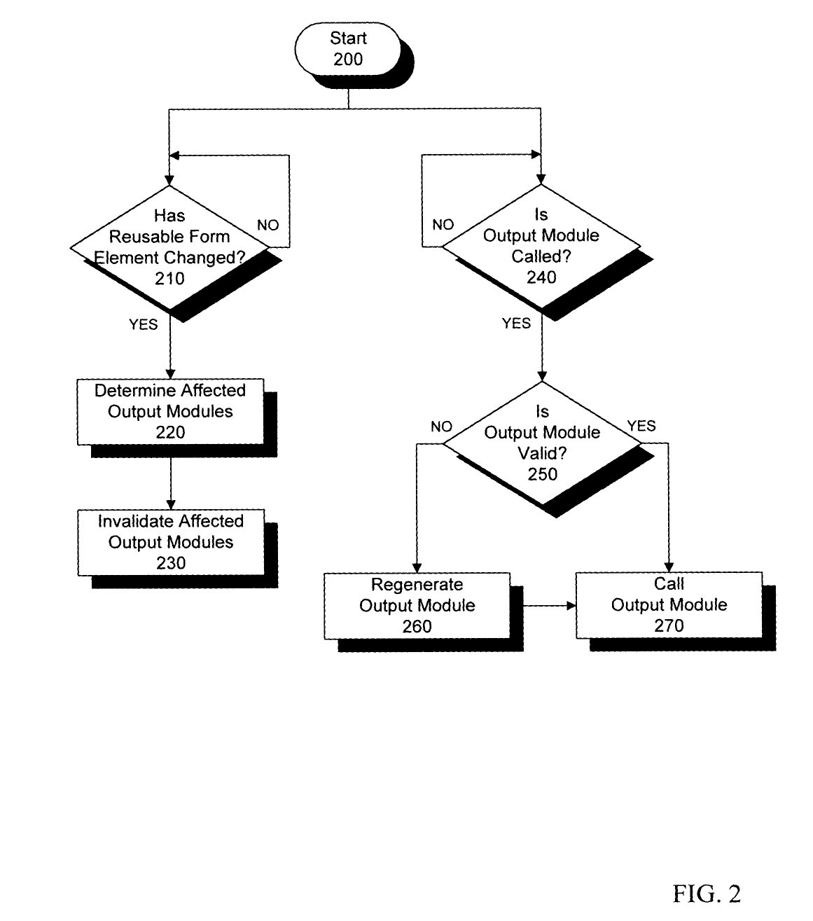

FIG. 2 depicts a process for implementing reusable form elements in accordance with an embodiment of the present invention. In a form-based development and runtime environment (step 200), when a form developer changes a reusable form element (step 210), the affected output modules are determined (step 220) and invalidated (step 230). Thus, when an application program calls an output module (step 240), the output module is first tested for validity (step 250) before it is called (step 270); if the output module is invalid, it is regenerated (step 260) before it is called.

Embodiments described below illustrate a form-based development and runtime environment within which the present invention may be implemented.

### ARCHITECTURE

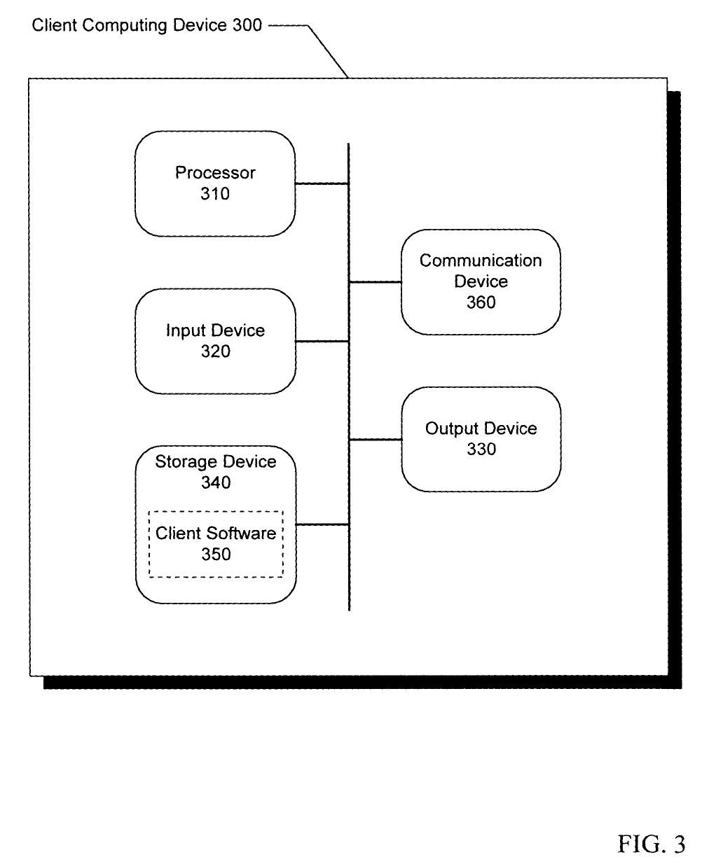

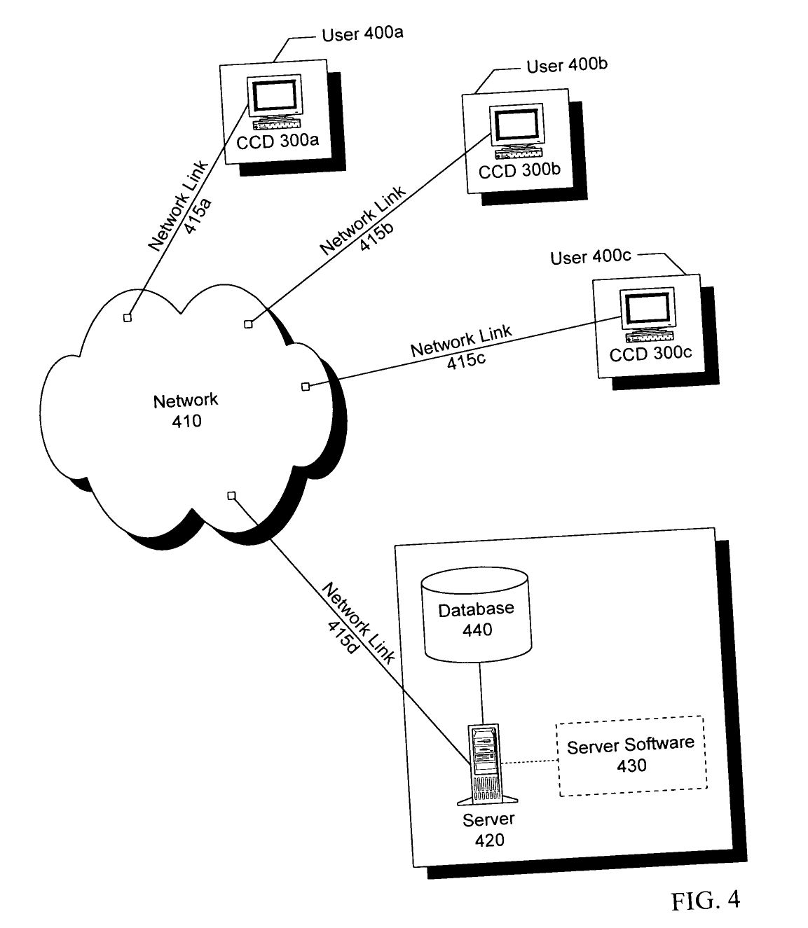

FIGS. 3 and 4 illustrate the components of a basic development and runtime environment in accordance with an embodiment of the present invention. FIG. 3 depicts client computing device 300, which may be a workstation, personal computer, handheld personal digital assistant (“PDA”), or any other type of microprocessor-based device. Client computing device 300 may include a processor 310, input device 320, output device 330, storage device 340, client software 350, and communication device 360.

Input device 320 may include a keyboard, mouse, pen-operated touch screen, voice-recognition device, or any other device that accepts input. Output device 330 may include a monitor, printer, disk drive, speakers, or any other device that provides output.

Storage device 340 may include volatile and nonvolatile data storage, including one or more electrical, magnetic or optical memories such as a RAM, cache, hard drive, CD-ROM drive, tape drive or removable storage disk. Communication device 360 may include a modem, network interface card, or any other device capable of transmitting and receiving signals over a network. The components of client computing device 300 may be connected via an electrical bus or wirelessly.

Client software 350 may be stored in storage device 340 and executed by processor 310, and may include, for example, the client side of a client/server application such as a form building application like Smart Forms that embodies the functionality of the present invention.

FIG. 4 illustrates a network architecture for a development and runtime environment in accordance with an embodiment of the present invention. According to one particular embodiment, when user 400a invokes a form building application, client software 350 of client computing device 300a communicates with server software 430 (e.g., the server side of the form building application) of server 420 via network link 415a, network 410, and network link 415d.

Network link 415 may include telephone lines, DSL, cable networks, T1 or T3 lines, wireless network connections, or any other arrangement that implements the transmission and reception of network signals. Network 410 may include any type of interconnected communication system, and may implement any communications protocol, which may secured by any security protocol.

Server 420 includes a processor and memory for executing program instructions, as well as a network interface, and may include a collection of servers. In one particular embodiment, server 420 may include a combination of enterprise servers such as an application server and a database server. Database 440 may represent a relational or object database, and may be accessed via a database server.

Client computing device 300 and server 420 may implement any operating system, such as Windows or UNIX. Client software 350 and server software 430 may be written in any programming language, such as ABAP, C, C++, Java or Visual Basic. Server software 440 may be built on an enterprise application platform, such as SAP Web Application Server 6.2.

### FORM ELEMENT REUSABILITY

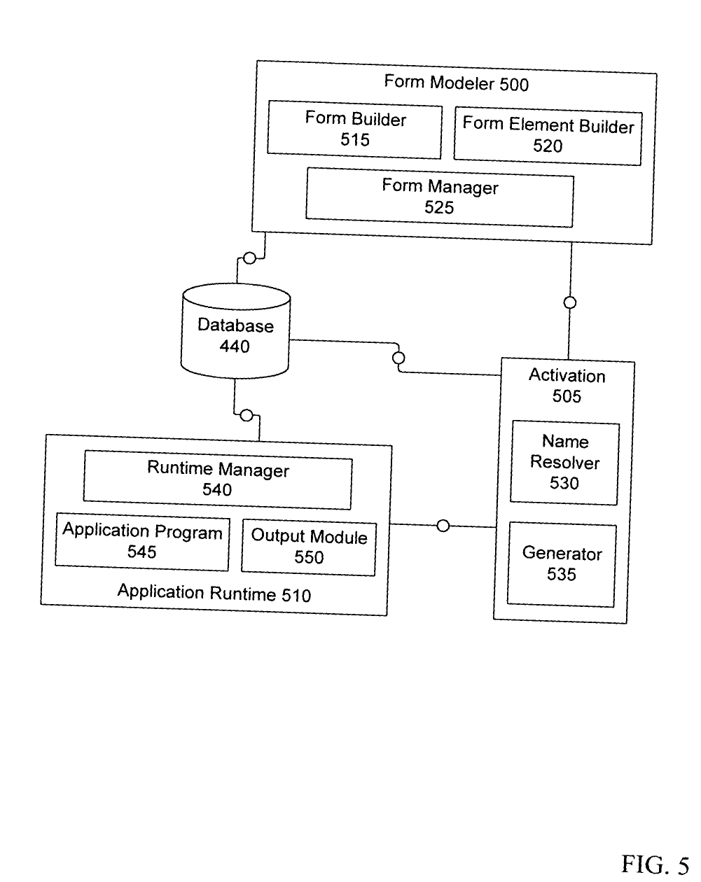

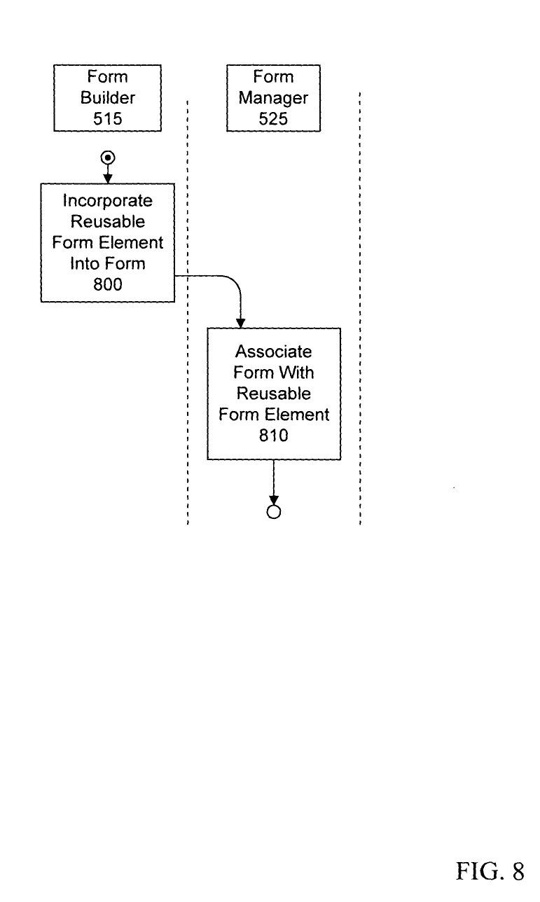

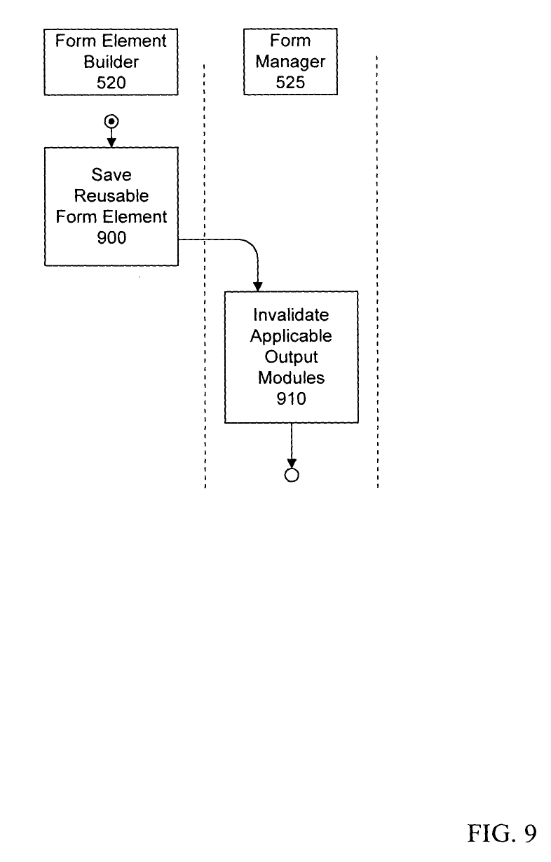

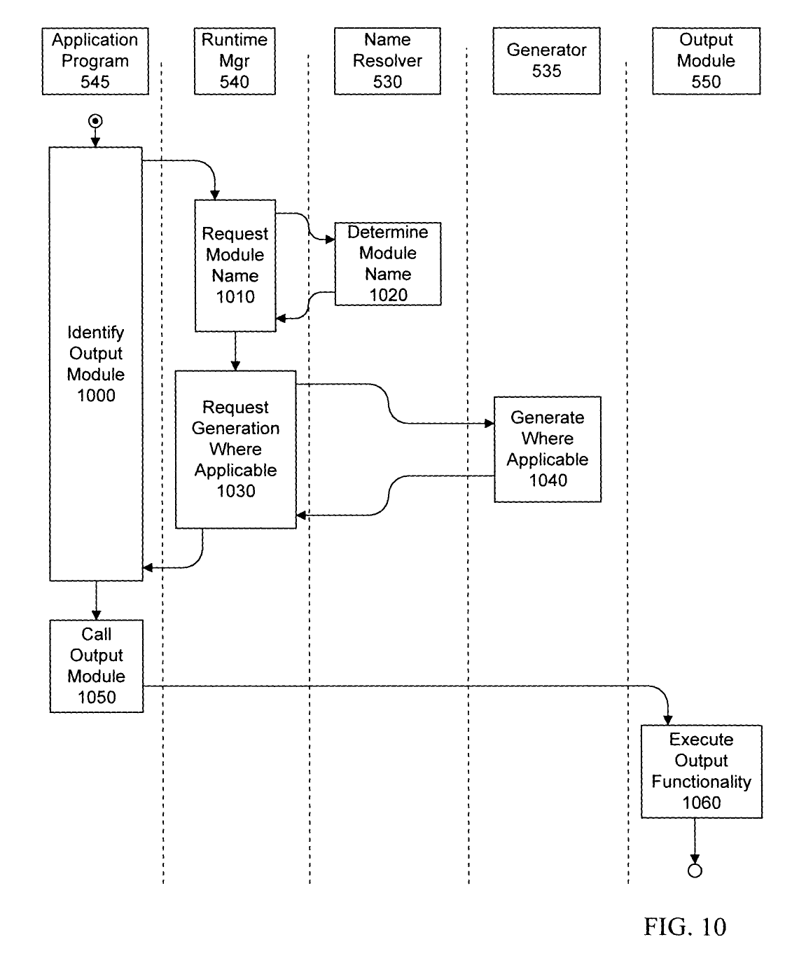

Within a form-based development and runtime environment as illustrated in FIG. 5, an embodiment of the present invention may be implemented to enable form manager 525 to associate forms with reusable form elements (FIG. 8) so that the appropriate form output modules are invalidated when a reusable form element is changed (FIG. 9). This invalidation enables runtime manager 540 to regenerate invalidated form output modules before calling them (FIG. 10).

Form modeler 500 may include several components, such as form builder 515, form element builder 520 and form manager 525, that may implement particular functionality associated with the building and managing reusable form elements. Activation 505 may similarly include several components, such as name resolver 530 and generator 535, that may implement particular functionality associated with the identification and generation of reusable form elements for application programs. Application runtime 510 may include several components, such as application program 545, output module 550 and runtime manager 540, that may implement particular functionality associated with the calling of form output modules that include reusable form elements. Form modeler 500, activation 505 and application runtime 510 are all connected to some form of storage, such as database 440 or file system storage (local and/or remote).

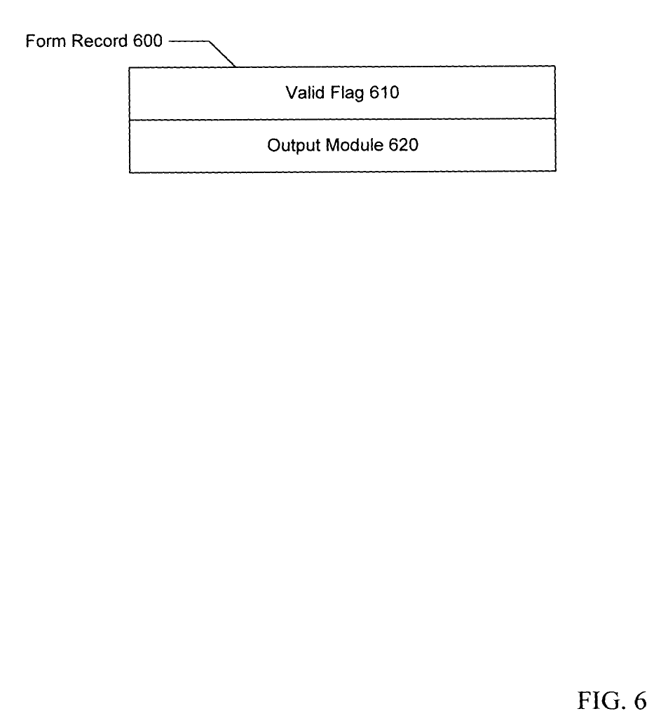

According to this embodiment, form manager 525 tracks, for each form, the corresponding form output module and its validity. This tracking may be implemented through the use of a form record 600 data structure, as shown in FIG. 6, which includes valid flag 610 and output module 620. Valid flag 610 may represent a Boolean value (TRUE/FALSE) designating whether a reusable form element associated with the output module has been changed since the last activation. Output module 620 may represent either the output module itself or a pointer (reference) to the output module.

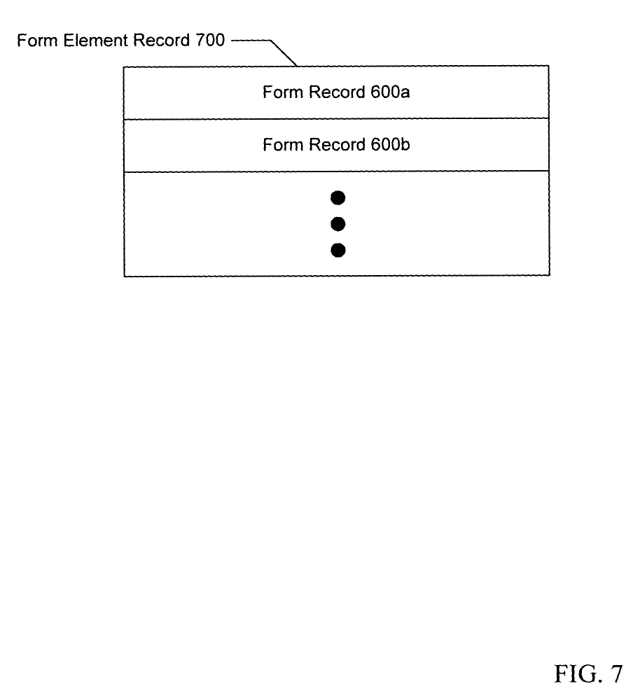

Form manager 525 also tracks, for each reusable form element, the existing forms that have incorporated that particular reusable form element through a type of form library membership. This tracking may be implemented through the use of a form element record 700 data structure, as shown in FIG. 7, which includes a listing of associated form record 600 data structures. Form record 600 may represent either the form record itself or a pointer (reference) to the form record.

Thus, as shown in FIG. 8, when a user incorporates a reusable form element into a form using form builder 515 (step 800), form manager 525 associates that form with the incorporated reusable form element (step 810) by adding an appropriate form record 600 entry to the form element record 700 representing the incorporated reusable form element. Upon activation, generator 535 generates the corresponding output module and associates it with the appropriate form record 600 along with a valid flag 610 entry of TRUE. As shown in FIG. 9, when the incorporated reusable form element is later changed (step 900), form manager 525 invalidates all applicable output modules (step 910) by accessing the list of form records 600 from the incorporated reusable form element's form element record 700, and changes their valid flag 610 entries to FALSE.

By doing this, runtime manager 540 can assure that application program 545 never calls an invalid output module, as shown in FIG. 10. According to this embodiment, when application program 545 is ready to start the form output process, it first attempts to identify the appropriate output module (step 1000). This identification request may be utilized because the coding in application program 545 may only know the output module via a standard form name, such as “SF_EXAMPLE_{—}02”, whereas the internal output module name, such as “/1BCDWB/SF00000048”, must be derived. Runtime manager 540 calls name resolver 530 (step 1010) to determine the internal output module name (step 1020). Once runtime manager 540 can identify the desired output module, it checks to see if the output module is invalid by checking the valid flag 610 entry of the appropriate form record 600 (step 1030); if the output module is invalid, runtime manager 540 calls generator 535 to regenerate the output module (step 1040). Then application program 545 is ready to call the output module (step 1050) to execute its output functionality (step 1060).

### REUSABLE FORM ELEMENT REPRESENTATION

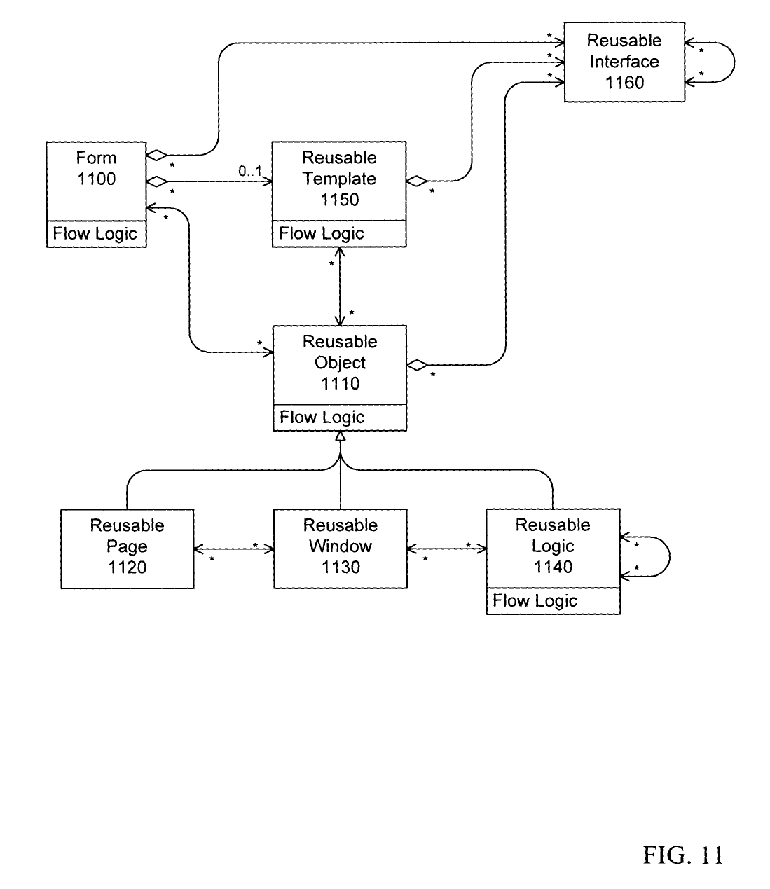

FIG. 11 illustrates a UML class diagram representing possible reusable form elements in accordance with an embodiment of the present invention. According to this embodiment, form 1100 could include reusable object 1110, reusable template 1150 and reusable interface 1160. Reusable object 1110 may include reusable page 1120, reusable window 1130 and reusable logic 1140. Each reusable form element includes any one or more nodes or parts of a form that are validated before being called according to the above process descriptions.

Reusable Templates/Partial Forms

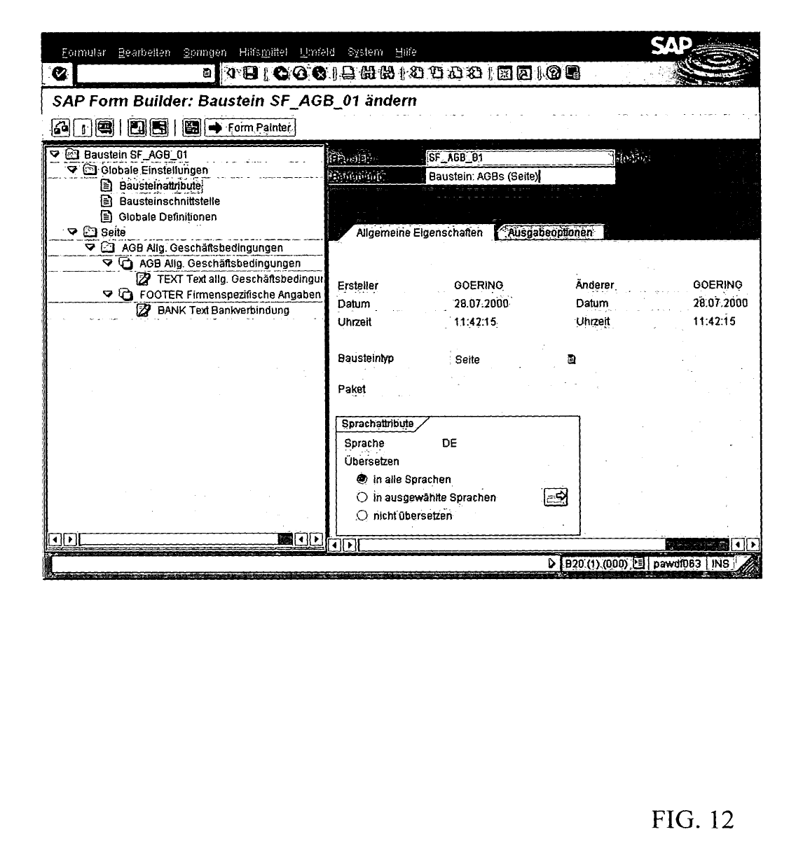

FIG. 12 is a screen shot of a form element builder 520 GUI for building reusable form pages in accordance with an embodiment of the present invention. Using this GUI, user 400 can create and maintain a reusable form element that represents one or more form pages that may be stored in database 440 for later incorporation into desired forms. The form element builder 520 GUI may be implemented as a stripped down version of form builder 515, focusing solely on the creation/modification of particular types of form elements (e.g., form pages). In the navigation tree of the form element builder of FIG. 12, the node entitled “Seite” (“Page” in English), along with all of its inferior nodes, represents a reusable page form element. Reusable page form elements may include an entire form page with page attributes, including windows and flow logic. Reusable window form elements, on the other hand, may include an entire window with window attributes, including flow logic.

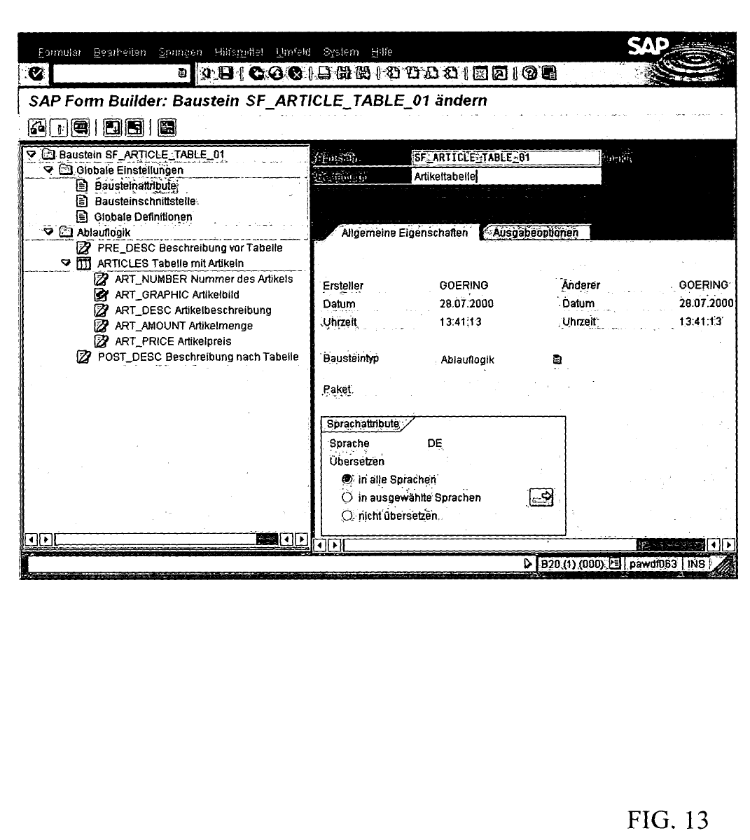

FIG. 13 is a screen shot of a form element builder 520 GUI for building reusable form logic in accordance with an embodiment of the present invention. Using this GUI, user 400 can create and maintain a reusable form element that represents flow logic that may be stored in database 440 for later incorporation into desired forms. In the navigation tree of the form element builder of FIG. 13, the node entitled “Ablauflogik” (“Flow Logic” in English), along with all of its inferior nodes, represents a reusable flow logic form element. In this particular embodiment, the “PRE-DESC” inferior node defines a description to appear in the form before a table output, the “ARTICLES” node defines the table output (e.g., multiple items of an order), and the “POST-DESC” inferior node defines a description to appear in the form after the table output. Note that this reusable form element is stored under the module name “SF_ARTICLE_TABLE_{—}01”.

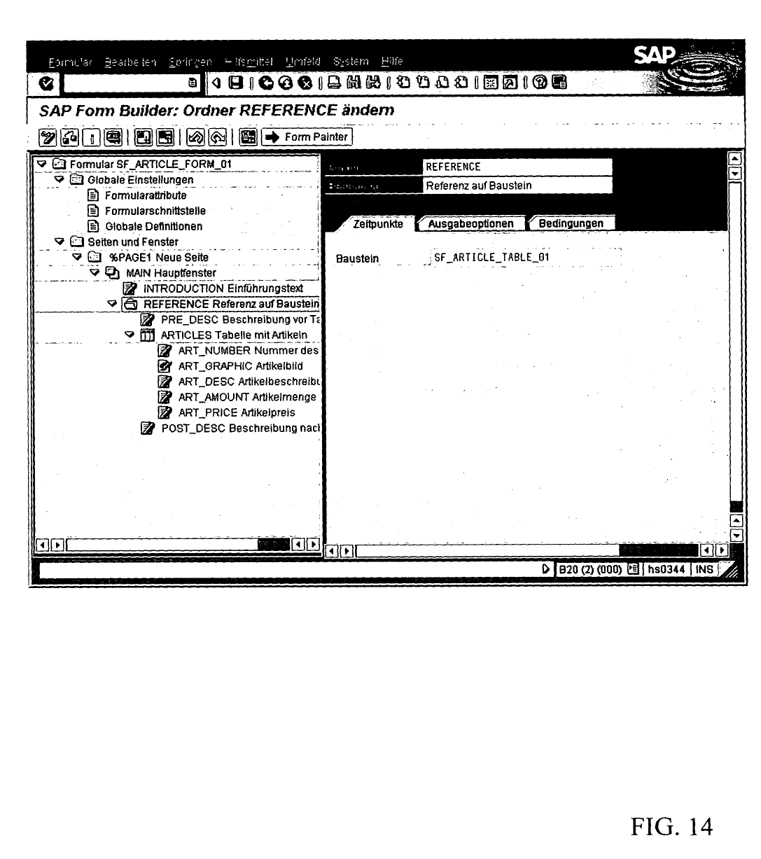

FIG. 14 is a screen shot of a form builder 515 GUI for incorporating reusable form logic into a form building application in accordance with an embodiment of the present invention. In order to incorporate the above reusable form logic element into a form, form builder 515 may allow user 400 to select a “REFERENCE” node, as shown in FIG. 14, which enables user 400 to enter the name of a stored reusable form element (e.g., “SF_ARTICLE_TABLE_{—}01” of FIG. 13) to incorporate that element into the current form. In one embodiment, such “REFERENCE” nodes may be read-only.

Reusable Form Interfaces

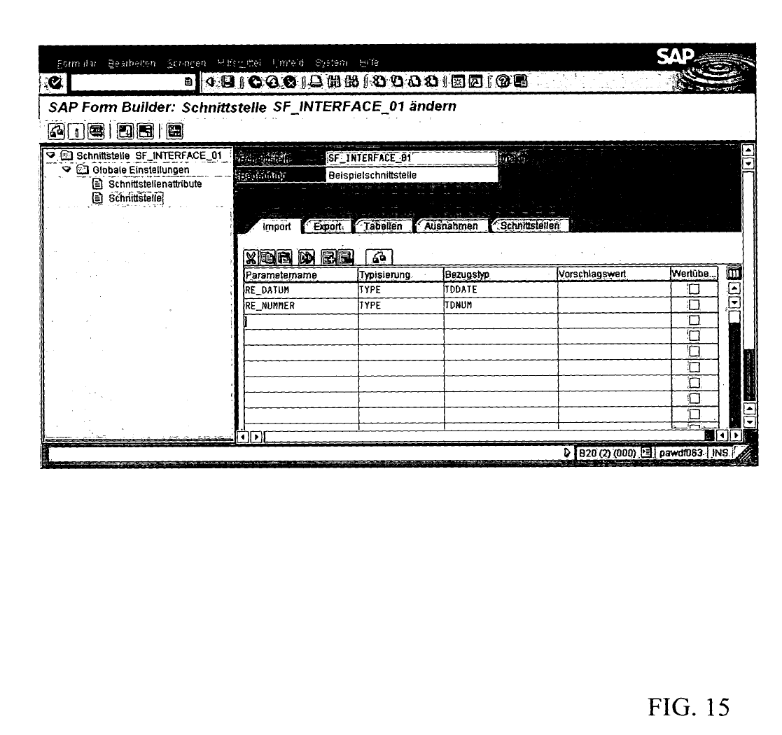

FIG. 15 is a screen shot of a form element builder 520 GUI for building reusable interfaces in accordance with an embodiment of the present invention. Using this GUI, user 400 can create and maintain a reusable form element that represents a form interface that may be stored in database 440 for later incorporation into desired forms. In the navigation tree of the form element builder of FIG. 15, the node entitled “Schnittstelle” (“Interface” in English), along with all of its inferior nodes, represents a reusable interface form element. Note that this reusable form element is stored under the module name “SF_INTERFACE_{—}01”.

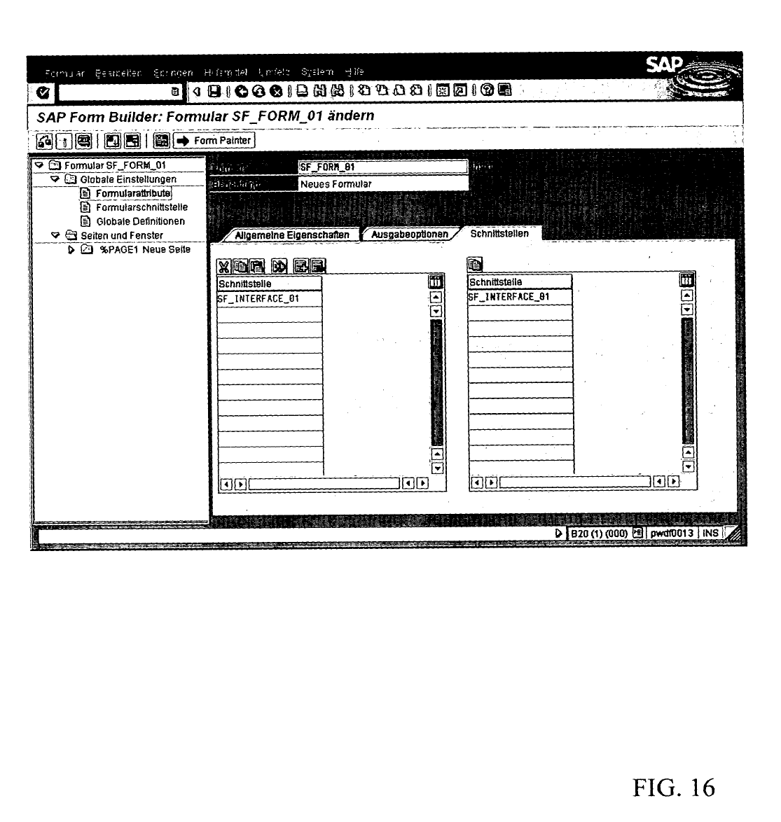

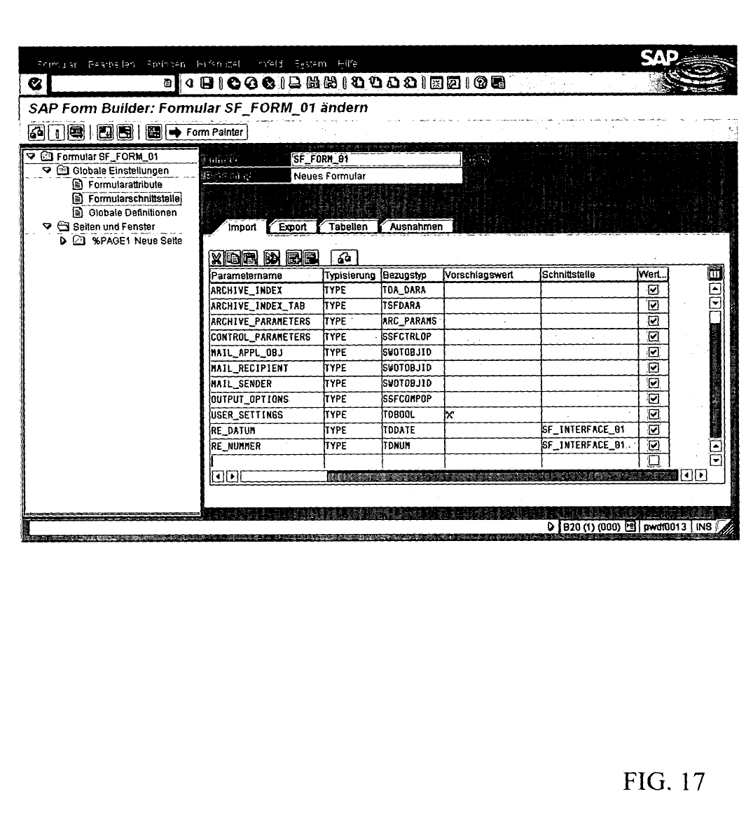

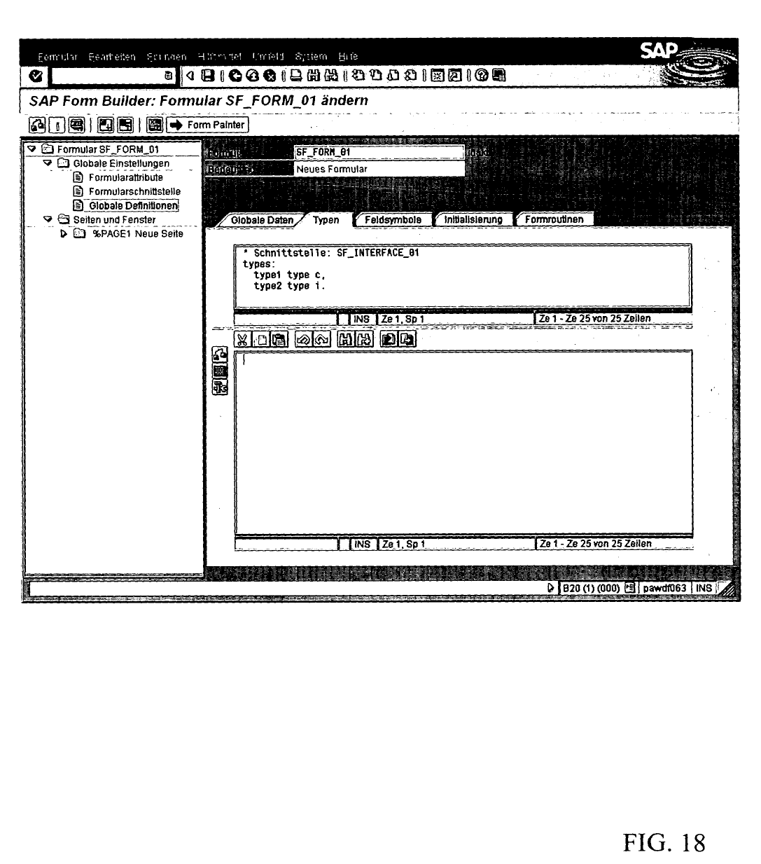

FIGS. 16-18 are screen shots of a form builder 515 GUI for incorporating reusable form interfaces into a form building application in accordance with an embodiment of the present invention. In FIG. 16, two lists are shown on the interface (“Schnittstellen”) tab: the right-hand list may display the interfaces that are used in the form as a result of the attachment of reusable sub-forms (i.e., partial forms) and form templates (shaded because it may be read-only), the left-hand list may display the interfaces added by user 400. In FIG. 17, an additional interface (“Schnittstellen”) column may be added on the “Import” tab to allow user 400 to see which interface entries are from a reusable interface, and which are not. And in FIG. 18, global definitions with the global data, types, field symbols, initialization and form routines (the “Global Definition” or “Globale Definitionen” node in the navigation tree) may be enhanced to include the content of the incorporated reusable form interfaces (in seen in the “Type” or “Typen” tab), although the content associated with the incorporated reusable form interfaces may remain read-only.

Several embodiments of the invention are specifically illustrated and/or described herein. However, it will be appreciated that modifications and variations of the invention are covered by the above teachings and within the purview of the appended claims without departing from the spirit and intended scope of the invention.

1. A computer system for generating output modules in a form-based application runtime environment, comprising:
a form manager component configured to receive an indication that a reusable form element has been changed, determine which output modules from a set of output modules are affected by the changed form element, and invalidate the affected output modules; and
a runtime manager component configured to receive a request for an output module from the set of output modules and cause regeneration of the requested output module if the requested output module has been invalidated.

2. The system of claim 1, wherein the indication is received when changes to the reusable form element are saved.

3. The system of claim 1, wherein the affected output modules are determined by referencing a record data structure.

4. The system of claim 1, wherein the affected output modules are invalidated by marking a flag associated with each affected output module as invalid.

5. The system of claim 1, wherein the request for the output module received by the runtime manager is a request to identify the output module.

6. The system of claim 1, wherein the reusable form element is one of a form page and a form window.

7. The system of claim 1, wherein the reusable form element is form logic.

8. The system of claim 1, wherein the reusable form element is a form interface.

9. A computer-implemented method for generating output modules in a form-based application runtime environment, comprising:
receiving an indication that a reusable form element has been changed;
determining which output modules from a set of output modules are affected by the changed form element;
invalidating the affected output modules;
receiving a request for an output module from the set of output modules; and
regenerating the requested output module if the requested output module has been invalidated.

10. The method of claim 9, wherein the indication is received when changes to the reusable form element are saved.

11. The method of claim 9, wherein the affected output modules are determined by referencing a record data structure.

12. The method of claim 9, wherein the affected output modules are invalidated by marking a flag associated with each affected output module as invalid.

13. The method of claim 9, wherein the request for the output module received by the runtime manager is a request to identify the output module.

14. The method of claim 9, wherein the reusable form element is one of a form page and a form window.

15. The method of claim 9, wherein the reusable form element is form logic.

16. The method of claim 9, wherein the reusable form element is a form interface.

17. A computer-implemented dynamic form building method, comprising:
responsive to a call to start a form output process based on an identified form:
determining whether a previously generated output module associated with the identified form in an output module library has been marked as invalid;
if so:
regenerating the output module; and
storing the regenerated output module in the output module library along with a marker to indicate that the output module is valid.

18. The method of claim 17, wherein the regeneration of the output module includes compiling changed reusable form elements into the output module.

19. A computer-implemented form library maintenance method, comprising:
upon revision to a form element, identifying from form element membership information which forms from a form library are associated with the revised form element, and
marking each of the identified forms in the form library as invalid.
